(19) United States
(12) Patent Application Publication
(10) Pub. No.: US 2021/0320768 A1
(43) Pub. Date: Oct. 14, 2021

(54) METHOD, DEVICE AND COMPUTER READABLE MEDIUM FOR IAB TRANSMISSION

(71) Applicant: NEC CORPORATION, Tokyo (JP)

(72) Inventors: Fang YUAN, Beijing (CN); Gang WANG, Beijing (CN)

(73) Assignee: NEC CORPORATION, Tokyo (JP)

(21) Appl. No.: 17/269,821

(22) PCT Filed: Aug. 27, 2018
(86) PCT No.: PCT/CN2018/102557

§ 371 Date: Feb. 19, 2021

(51) Int. Cl. H04L 5/00; H04L 5/16; H04B 17/345

(52) U.S. Cl. CPC H04L 5/0048; H04B 17/345; H04L 5/16

(57) ABSTRACT

Embodiments of the present disclosure relate to methods, devices and computer readable media for SDM IAB transmission. In example embodiments, a method implemented in a network device includes determining, at a first device, a first resource set and a second resource set, the first device operating in a half-duplex manner as a relay between a second device and a third device, the first resource set being configured to the first device for a first link between the first device and the second device, the second resource set being configured to the first device for the first link or to the third device for a second link between the first device and the third device. The method further includes transmitting a first reference signal on the first resource set for channel measurement and a second reference signal on the second resource set for interference measurement.

### TECHNICAL FIELD

Embodiments of the present disclosure generally relate to the field of communication, and in particular, to methods, devices and computer readable media for integrated backhaul and access (IAB) transmission.

### BACKGROUND

Communication technologies have been developed in various communication standards to provide a common protocol that enables different wireless devices to communicate on a municipal, national, regional, and even global level. An example of an emerging communication standard is new radio (NR), for example, 5G radio access. NR is a set of enhancements to the Long Term Evolution (LTE) mobile standard promulgated by Third Generation Partnership Project (3GPP). It is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL) as well as support beamforming, multiple-input multiple-output (MIMO) antenna technology, and carrier aggregation.

Regarding the IAB deployment scenarios, it has been agreed that in-band IAB scenarios including TIME Division Multiplexing (TDM)/Frequency Division Multiplexing (FDM)/Space Division Multiplexing (SDM) of access and backhaul links subject to half-duplex constraint at an IAB node should be supported. It has also been agreed that downlink IAB transmissions (transmissions from an IAB node to child IAB nodes and user equipment (UEs) directly under the IAB node) should be scheduled by the IAB node itself and that uplink IAB transmission (transmissions from an IAB node to its parent node) should be scheduled by the parent node. However, there still remain questions regarding the MIMO operation at the IAB node.

### SUMMARY

In general, example embodiments of the present disclosure provide methods, devices and computer readable media for beam information based positioning.

In a first aspect, there is provided a method for communication. The method comprises determining, at a first device, a first resource set and a second resource set, the first device operating in a half-duplex manner as a relay between a second device and a third device, the first resource set being configured to the first device for a first link between the first device and the second device, the second resource set being configured to the first device for the first link or to the third device for a second link between the first device and the third device; and transmitting a first reference signal on the first resource set for channel measurement and a second reference signal on the second resource set for interference measurement.

In a second aspect, there is provided a method for communication. The method comprises receiving, from a first device and at a second device, a first reference signal on a first resource set and a second reference signal on a second resource set, the first device operating in a half-duplex manner as a relay between the second device and a third device, the first resource set being configured to the first device for a first link between the first device and the second device, the second resource set being configured to the first device for the first link or to the third device for a second link between the first device and the third device; and performing channel measurement on the first reference signal and interference measurement on the second reference signal.

In a third aspect, there is provided a device. The device includes a processor; and a memory coupled to the processing unit and storing instructions thereon, the instructions, when executed by the processing unit, causing the device to perform the method according to the first aspect.

In a fourth aspect, there is provided a device. The device includes a processor; and a memory coupled to the processing unit and storing instructions thereon, the instructions, when executed by the processing unit, causing the device to perform the method according to the second aspect.

In a fifth aspect, there is provided a computer readable medium having instructions stored thereon, the instructions, when executed on at least one processor, causing the at least one processor to carry out the method according to the first aspect.

In a sixth aspect, there is provided a computer readable medium having instructions stored thereon, the instructions, when executed on at least one processor, causing the at least one processor to carry out the method according to the second aspect.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 shows a flowchart of an example method in accordance with some embodiments of the present disclosure;

FIG. 3 shows a flowchart of an example method in accordance with some other embodiments of the present disclosure;

FIG. 4 is a schematic diagram illustrating a process according to some embodiments of the present disclosure;

FIG. 5 shows schematic diagrams illustrating resource sets configured for the first link and the second link according to some embodiments of the present disclosure;

FIGS. 6A-6C show schematic diagrams illustrating different configurations of two resource sets according to some embodiments of the present disclosure;

FIG. 7 shows schematic diagrams illustrating resource sets configured for the first link and the second link according to some embodiments of the present disclosure;

FIGS. 8A-8D show schematic diagrams illustrating different configurations of two resource sets according to some embodiments of the present disclosure;

FIG. 9 shows schematic diagrams illustrating resource sets configured for the first link and the second link according to some embodiments of the present disclosure;

FIGS. 10A-10D show schematic diagrams illustrating different configurations of two resource sets according to some embodiments of the present disclosure; and

FIG. 11 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” or “base station” (BS) refers to a device which is capable of providing or hosting a cell or coverage where terminal devices can communicate. Examples of a network device include, but not limited to, a Node B (NodeB or NB), an Evolved NodeB (eNodeB or eNB), a NodeB in new radio access (gNB) a Remote Radio Unit (RRU), a radio head (RH), a remote radio head (RRH), a low power node such as a femto node, a pico node, and the like. For the purpose of discussion, in the following, some embodiments will be described with reference to gNB as examples of the network device.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, image capture devices such as digital cameras, gaming devices, music storage and playback appliances, or Internet appliances enabling wireless or wired Internet access and browsing and the like.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As mentioned above, it has been agreed that in-band IAB scenarios including TDM/FDM/SDM of access and backhaul links subject to half-duplex constraint at an IAB node should be supported. Specifically, mechanisms for efficient TDM/FDM/SDM multiplexing of access/backhaul traffic across multiple hops considering an IAB node half-duplex constraint should be studied. The following solutions for the different multiplexing options can be further studied:
Mechanisms for orthogonal partitioning of time slots or frequency resources between access and backhaul links across one or multiple hops
Utilization of different DL/UL slot configurations for access and backhaul links
DL and UL power control enhancements and timing requirements to allow for intra-panel FDM and SDM of backhaul and access links.
Interference management including cross-link interference

Conventionally, in LTE, to support the transmission from a donor to a relay and the transmission from the relay to the donor, Multicast Broadcast Single Frequency Network (MBSFN) subframes in the access link are reserved for the backhaul link. To address the IAB transmission in NR, some solutions have been proposed. For example, in a solution regarding the physical layer design for NR IAB, resource coordination among IAB nodes/donor is proposed. After resource coordination, each IAB node will know its possible backhaul resource configuration and also the access resource configuration. For each IAB node, the slot location for its backhaul-only link with its serving node, access-only link (including the backhaul link for its child IAB node), the backhaul & access sharing link and the unknown will be determined via the resource coordination. However, MIMO operation for a SDM IAB node which operates in a half-duplex manner has not been addressed.

To solve the above problem, the present disclosure proposes solutions in which reference signals are used to support the SDM IAB transmission in an IAB node. As an example, a sounding reference signal (SRS) is one of the important reference signals and is configured by a network device to support uplink channel measurements, in non-codebook based UL MIMO transmission, codebook-based UL MIMO transmission, etc. An SRS signal may be transmitted on an SRS resource by using a beam, or a combination of beam and precoder. A beam generally refers to, but not limited to, a wideband analog beamforming applied to for example a phased antenna array with one radio-frequency (RF) chain. A precoder refers to a digital precoding applied to for example multiple antenna ports on multiple RF chains.

For non-codebook based UL MIMO transmission, a terminal device may precode SRS signals with different precoders and a network device may select one or more precoders based on the channel measurement and indicate the selected precoders by means of an SRS Resource Indication (SRI). For illustrative purposes, Table 1 illustrates the definition of SRI for non-codebook based UL MIMO transmission.

TABLE 1
SRI for non-codebook based UL MIMO transmission.

| Field | Value |
|---|---|
| SRS resource indicator if the higher layer parameter txConfig = nonCodebook, where N_{SRS} is the number of configured SRS resources in the SRS resource set. | $⌈ {log}_{2} ( {\sum }_{k = 1}^{min \{ {L}_{max} , {N}_{SRS} \}} ( \begin{matrix}{N}_{SRS} \\ k\end{matrix} ) ) ⌉$ |

Table 1 illustrates the meaning of the SRI field and how to determine its value. In addition, Table 2 further illustrates an example mapping of the SRI field to index for non-codebook based Physical Uplink Shared Channel (PUSCH) transmission under N_{SRS}=2, 3, 4.

TABLE 2
SRI indication for non-codebook based PUSCH transmission Lₘₐₓ = 2

| | SRI(s) | Bit field mapped | SRI(s) | Bit field mapped | SRI(s), |
|---|---|---|---|---|---|
| + | N_{SRS} = 2 | to index | N_{SRS} = 3 | to index | N_{SRS} = 4 |
| 0 | 0 | 0 | 0 | 0 | 0 |
| 1 | 1 | 1 | 1 | 1 | 1 |
| 2 | 0, 1 | 2 | 2 | 2 | 2 |
| 3 | reserved | 3 | 0, 1 | 3 | 3 |
| | | 4 | 0, 2 | 4 | 0, 1 |
| | | 5 | 1, 2 | 5 | 0, 2 |
| | | 6-7 | reserved | 6 | 0, 3 |
| | | | | 7 | 1, 2 |
| | | | | 8 | 1, 3 |
| | | | | 9 | 2, 3 |
| | | | | 10-15 | reserved |

For example, for the case of N_{SRS}=4, the network device may select precoder 1 and 2 and indicate to the terminal device in the SRI field with a value of 7. Therefore, the selected precoders for SDM IAB transmission can be indicated to the IAB node by the IAB donor or parent IAB node.

According to embodiments of the present disclosure, there is proposed a solution for SDM IAB transmission. In this solution, two reference signals precoded with two different set of precoders are transmitted by an IAB node using two resource sets. An IAB donor or a parent IAB node may perform channel measurement and interference measure measurement on the two resource sets to, for example, determine at least one preferred precoder to be used for the data transmission between the IAB node and the IAB donor or the parent IAB node. In this way, the IAB node and the IAB donor or the parent IAB node can communicate with each other with reduced interference.

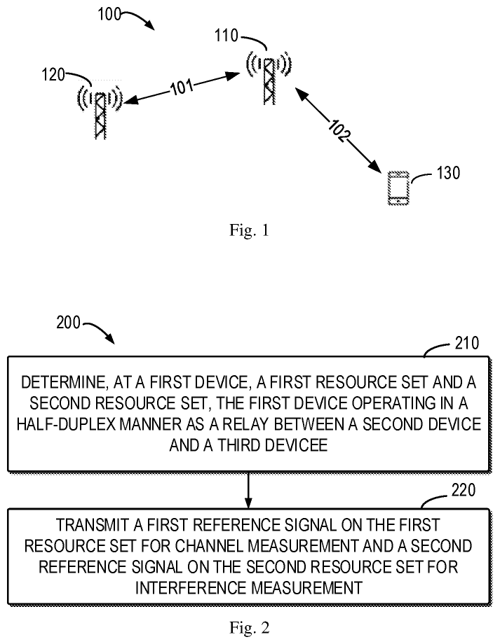

Principle and implementations of the present disclosure will be described in detail below with reference to FIGS. 1-11.

FIG. 1 shows an example communication network 100 in which embodiments of the present disclosure can be implemented. The network 100 includes a first device 110, a second device 120 and a third device 130. The first device 110 operates as a relay between the second device 120 and the third device 130, and may also be referred to as an IAB node. The second device 120 may be a gNB, which may be also referred to as an IAB donor. The second device 120 may alternatively be a parent node of the first device 110. Although the third device 130 is shown as a terminal device (such as UE) in FIG. 1, the third device 130 may also be a child node of the first device 110 or another relay.

In some embodiments, the first device 110 may comprise an IAB node and the second device 120 may comprise an IAB donor. In some embodiments, the first device 110 may comprise an IAB node and the second device 120 may comprise a parent node of the IAB node.

It is to be understood that the number of devices is only for the purpose of illustration without suggesting any limitations. The network 100 may include any suitable number of devices adapted for implementing embodiments of the present disclosure.

In the network 100, the first device 110 and the second device 120 can communicate data and control information to each other over a first link 101. The first device 110 and the third device 130 can communicate data and control information to each other over a second link 102. The first link 101 is may be a backhaul link (BL) while the second link 102 may be a BL or an access link (AL). Specifically, when the third device 130 is a terminal device, the second link 102 is an AL. When the third device 130 is a child node of the first device 110, the second link 102 is another BL.

Depending on the communication technologies, the network 100 may be a Code Division Multiple Access (CDMA) network, a Time Division Multiple Address (TDMA) network, a Frequency Division Multiple Access (FDMA) network, an Orthogonal Frequency-Division Multiple Access (OFDMA) network, a Single Carrier-Frequency Division Multiple Access (SC-FDMA) network or any others. Communications discussed in the network 100 may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols. The techniques described herein may be used for the wireless networks and radio technologies mentioned above as well as other wireless networks and radio technologies. For clarity, certain aspects of the techniques are described below for LTE, and LTE terminology is used in much of the description below.

In operation, the first device 110 may transmit data to the second device 120 and the third device 130 concurrently. That is, the data transmission from the first device 110 to the second device 120 (also referred to as first data transmission herein) and the data transmission the first device 110 to the third device 120 (also referred to as second data transmission herein) may occur concurrently. The first data transmission may interfere the receipt of the second data transmission at the third device 130, and vice versa. This is called cross link interference (CLI). In embodiments of the present disclosure, CLI measurement is used to mitigate the interference between the first and second data transmission.

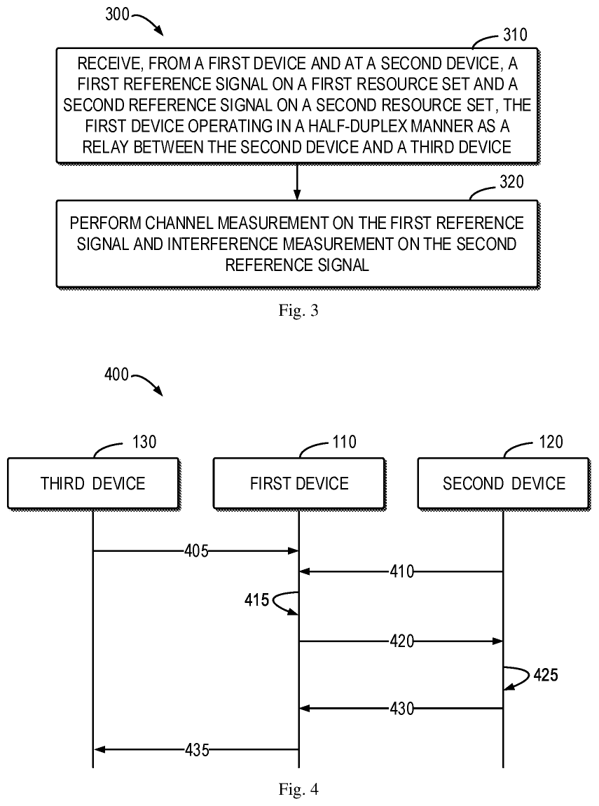

Implementations of the present disclosure will be described in detail below with reference to FIGS. 2-11. FIG. 2 illustrates a flowchart of an example method 200 for communication in accordance with some embodiments of the present disclosure. The method 200 can be implemented at the first device 110 shown in FIG. 1. It is to be understood that the method 200 may include additional blocks not shown and/or may omit some blocks as shown, and the scope of the present disclosure is not limited in this regard. For the purpose of discussion, the method 200 will be described with reference to FIG. 1.

At block 210, the first device 110 determines a first resource set and a second resource set. As mentioned above, the first device 110 operates in a half-duplex manner as a relay between the second device 120 and the third device 130. The first resource set is configured to the first device 110 for the first link 101 between the first device 110 and the second device 120. The second resource set is configured to the first device 110 for the first link 101 or to the third device 130 for the second link 102 between the first device 110 and the third device 120.

At block 220, the first device 110 transmits a first reference signal on the first resource set for channel measurement and a second reference signal on the second resource set for interference measurement. Different reference signals may be used as the first and second reference signals, such as SRS and a channel state information reference signal (CSI RS). Each of the first and second resource sets may include different number of resources and each of resources may be associated with different precoders.

In some embodiments, the first device 110 may transmit, to the second device 120 and on the first resource set, a first SRS and transmit, to the second device 120 and on the second resource set, a second SRS. In this case, the first resource set may be a first SRS resource set configured to the first device 110 for the first link 101, and the second resource set may be a second SRS resource set configured to the first device 110 for the first link 101. Both the two SRS resource sets may be configured by the second device 120 for the first device 110, and SRS request can be signaled from the second device 120 to the first device 110 to trigger the corresponding SRS transmission.

In some embodiments, the first device 110 may transmit, to the second device 120 and on the first resource set, an SRS and transmit, to the third device 130 and on the second resource set, a non-zero power CSI RS (NZP-CSI RS). In this case, the first resource set may be an SRS resource set configured to the first device 110 for the first link 101, and the second resource set may be an NZP-CSI RS resource set configured to the third device 130 for the second link 102.

In some embodiments, the first device 110 may transmit, to the second device 120 an on the first resource set, a first NZP-CSI RS and transmit, to the third device 130 and on the second resource set, a second NZP-CSI RS. In this case, the first resource set may be a first NZP-CSI RS resource set configured to the first device 110 for the first link 101, and the second resource set may be a second NZP-CSI RS resource set configured to the third device 130 for the second link 102.

As mentioned above, the first and second resource sets may have different configurations and may be associated with different precoders. The first resource set may be associated with a first set of precoders and the second resource set may be associated with a second set of precoders. The first set of precoders may be related to first data transmission from the first device 110 to the second device 120, and the second set of precoders may be related to second data transmission from the first device to the third device.

The first device 110 may determine the precoders to be used for first and second data transmission based on measurement of an associated reference signal. The first device 110 may determine the first set of precoders to be P1, P2, P3 and P4, for example, based on measurement of a CSI RS from the second device 120. The first device 110 may further determine the second set of precoders to be P5 and P6, for example, based on measurement of an SRS from the third device 130.

It is to be understood that the second set of precoders P5 and P6 are different from the first set of precoders P1, P2, P3 and P4. It is also to be understood that the first set of precoders are indicated by P1, P2, P3, P4 and the second set of precoders are indicated by P5, P6 merely for illustrative purpose. The first and second sets of precoders may include any suitable number of precoders.

In some embodiments, each resource in the first resource set is associated with one precoder in the first set of precoders. For example, there may be four resources in the first resource set and each of the four resources may be associated with P1, P2, P3 and P4, respectively. Each resource in the second resource set may be associated with one precoder in the second set of precoders. For example, there may be two resources in the second resource set and each of the two resources may be associated with P5 and P6, respectively.

In some scenario, a resource may correspond to a plurality of antenna ports, each of which is associated with a precoder. Thus, in some cases, a single resource in the first and second resource sets may be associated with a plurality of precoders.

In some embodiments, the first resource set may include one resource associated with the first set of precoders. For example, the first resource set may include only one resource, which is associated with P1, P2, P3 and P4. Each resource in the second resource set may be associated with one precoder in the second set of precoders, respectively. For example, there may be two resources in the second resource set and each of the two resources may be associated with P5 and P6, respectively.

In some embodiments, each resource in the first resource set may be associated with one precoder in the first set of precoders, respectively. For example, there may be four resources in the first resource set and each of the four resources may be associated with P1, P2, P3 and P4, respectively. The second resource set may include at least one resource associated with at least some precoders in the second set of precoders. For example, the first resource set may include only one resource which is associated with P5 and P6. In embodiments where the second set of precoders comprises additional precoders, such as P7 and P8, the first resource set may include two resources and each of the two resources may be associated with two precoders in the second set of precoders.

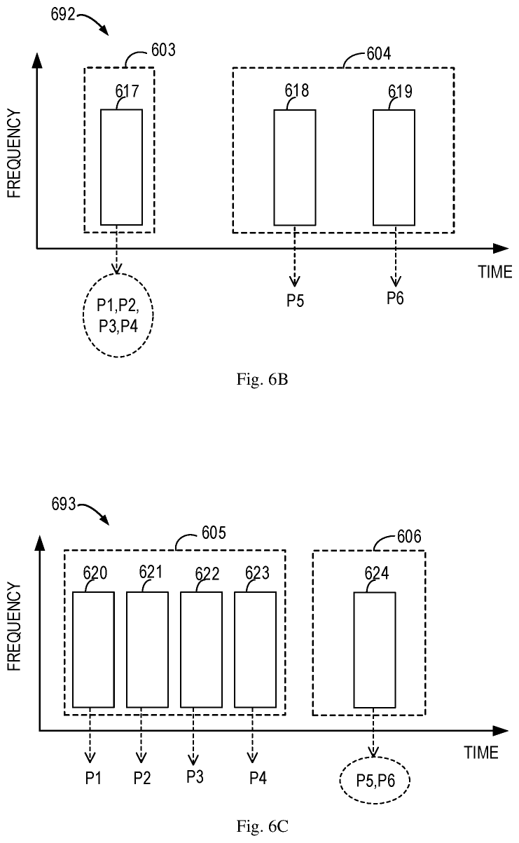

In the above embodiments, different reference signals and configurations of corresponding resource sets are used for channel measurement and interference measurements. It is to be understood that the features in the above embodiments can be combined. These embodiments will be further described below in detail with reference to FIGS. 4-10.

After transmitting the first and second reference signals, the first device 110 may receive from the second device 120 an indication indicating the information related to at least one precoder to be used for the first data transmission. The at least one precoder is selected from the first set of precoders P1, P2, P3, P4 by the second device 120 based on channel measurement on the first reference signal and interference measurement on the second reference signal. For example, the indication may be included in the SRI field which is received at the first device 110 along with an UL grant from the second device 120. As an example, and referring to Table 1, the value of the SRI field may be 7, which indicates that the precoders P1 and P2 are selected by the second device 120.

Then, the first device 110 may perform the first data transmission with the at least one selected precoder and perform the second data transmission with the second set of precoders. For example, if the first device 110 is indicated that precoders P1 and P2 are selected, the first device 110 may then perform the first data transmission with the precoders P1 and P2.

In some embodiments, the first device 110 may receive a first and second radio resource control (RRC) messages from the second device 120. The first RRC message may comprise a first configuration of the first resource set and a third configuration of a third resource set configured to the first device 110 for the first link 101, and the second RRC message may comprise a fourth configuration of a fourth resource set configured to the third device 130 for the second link 102 and a fifth configuration of a fifth resource set configured to the third device 130 for the second link 102.

The first device 110 may associate the first configuration with the fourth configuration and the third configuration with the fifth configuration. In this case, the second resource set may comprise one of the third resource set and the fifth resource set. For example, when the second reference signal is the second SRS as described above, the second resource set may be the third resource set. When the second reference signal is the NZP-CSI RS, the second resource set may be the fifth resource set. These embodiments will be described below in detail with reference to FIGS. 4-10.

In embodiments of the present disclosure, by means of reference signals for channel measurement and for interference measurement, the CLI between the first and second data transmission, for example, the CLI between data transmission on a backhaul link and an access link, can be alleviated. Therefore, SDM for IAB node can be supported and the data transmission can be achieved with reduced CLI interference.

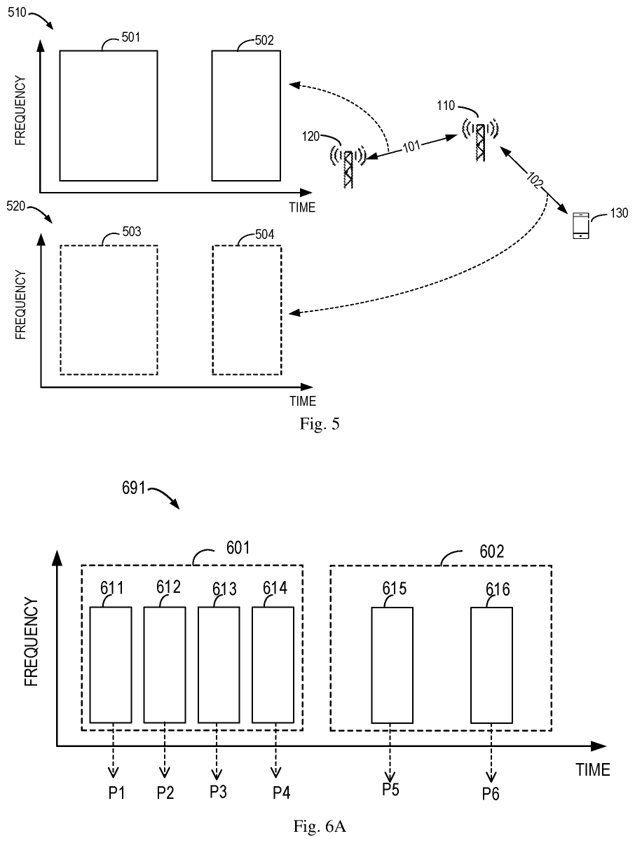

FIG. 3 illustrates a flowchart of an example method 300 for communication in accordance with some embodiments of the present disclosure. The method 300 can be implemented at the second device 120 shown in FIG. 1. It is to be understood that the method 300 may include additional blocks not shown and/or may omit some blocks as shown, and the scope of the present disclosure is not limited in this regard. For the purpose of discussion, the method 300 will be described with reference to FIG. 1.

At block 310, the second device 120 receives from the first device 110 a first reference signal on a first resource set and a second reference signal on a second resource set. As mentioned above, the first device 110 operates in a half-duplex manner as a relay between the second device 120 and the third device 130. The first resource set is configured to the first device 110 for the first link 101 between the first device 110 and the second device 120. The second resource set is configured to the first device 110 for the first link 101 or to the third device 130 for the second link 102 between the first device 110 and the third device 120. For example, the second device 120 may receive the first reference signal on the first resource set configured for channel measurement and receive the second reference signal on the second resource set configured for interference measurement. In some embodiments, the second reference signal may be transmitted to the third device 130, rather than the second device 120. In such cases, the second device 120 may also receive the second reference signal on a preconfigured resource set which shares the same time-frequency resources with the second resource set, for example, via overhearing.

In some embodiments, the second device 120 may receive on the first resource set a first SRS and receive on the second resource set a second SRS. In this case, the first resource set may be a first SRS resource set configured to the first device 110 for the first link 101, and the second resource set is a second SRS resource set configured to the first device 110 for the first link 101. Both the two SRS resource sets may be configured by the second device 120 for the first device 110, and SRS request can be signaled from the second device 120 to the first device 110 to trigger the corresponding SRS transmission

In some embodiments, the second device 120 may receive on the first resource set an SRS and receive an NZP-CSI RS as a reference signal for interference measurement. In this case, the first resource set may be an SRS resource set configured to the first device 110 for the first link 101, and the second resource set may be an NZP-CSI RS resource set configured to the third device 130 for the second link 102. In such embodiments, the NZP-CSI RS may be received on a corresponding ZP-CSI RS resource set, which shares the same time-frequency resources with the NZP-CSI RS resource set.

In some embodiments, the second device 120 may receive on the first resource set a first NZP-CSI RS, and receive a second NZP-CSI RS as a reference signal for interference measurement. In this case, the first resource set may be a first NZP-CSI RS resource set configured to the first device 110 for the first link 101, and the second resource set may be a second NZP-CSI RS resource set configured to the third device 130 for the second link 102. In such embodiments, the second NZP-CSI RS may be received on a corresponding ZP-CSI RS resource set, which shares the same time-frequency resources with the second NZP-CSI RS resource set.

In the above cases where the second resource set is an NZP-CSI RS resource set configured to the third device 130 for the second link 102, a corresponding ZP-CSI RS resource set is configured to the first device 110 for the first link 101. Therefore, although the NZP-CSI RS is not intended to the second device 120, it may receive and measure the NZP-CSI RS on the ZP-CSI RS resource set via overhearing.

As described with reference to FIG. 2, the first and second resource sets may have different configurations and may be associated with different precoders. The first resource set may be associated with the first set of precoders P1, P2, P3, P4, and the second resource set may be associated with a second set of precoders P5, P6.

In some embodiments, each resource in the first resource set may be associated with one precoder in the first set of precoders P1, P2, P3 and P4. Each resource in the second resource set may be associated with one precoder in the second set of precoders P5, P6. In some embodiments, the first resource set may include one resource associated with the first set of precoders P1, P2, P3 and P4. Each resource in the second resource set may be associated with one precoder in the second set of precoders P5, P6. In some embodiments, each resource in the first resource set may be associated with one precoder in the first set of precoders P1, P2, P3 and P4. The second resource set may include at least one resource associated with at least some precoders in the second set of precoders P5, P6.

As mentioned above with reference to FIG. 2, the different reference signals and configurations of corresponding resource sets can be combined. These embodiments will be further described below in detail with reference to FIGS. 4-10.

At block 320, the second device 120 performs channel measurement on the first reference signal and interference measurement on the second reference signal. The channel measurement and interference measurement may be used to facilitate the selection of UL transmission resources.

For example, the second device 120 may determine the qualities of the reference signals precoded with the first set of precoders P1, P2, P3, P4, based on the channel measurement. The second device 120 may further determine interference of the reference signals precoded with the second set of precoders P5, P6, based on the interference measurement. Then, the second device 120 may select at least one precoders from the first set of precoders P1, P2, P3, P4. The at least one selected precoders may have a better signal quality than other precoders, or may be less interfered by the second set of precoders P5, P6.

After that, the second device 120 may transmit to the first device 110 an indication indicating the at least one precoder. The second device 120 may include the indication in the SRI field which is transmitted to the first device 110 along with an UL grant for the first data transmission. For example, the SRI field with a value of 7 may indicate that the precoders P1 and P2 are selected by the second device 120.

In embodiments of the present disclosure, the CLI between data transmission on a backhaul link and an access link can be alleviated by means of reference signals for channel measurement and for interference measurement. Therefore, SDM for IAB node can be supported and the data transmission can be achieved with reduced interference.

As mentioned above, different reference signals and configurations of corresponding resource sets can be used for channel measurement and interference measurements. Such embodiments will be described below with reference to FIGS. 4-10.

As mentioned above with reference to FIG. 2, in some embodiments, SRSs may be used as both the first and second reference signals. Such embodiments are described with reference to FIGS. 4-6. FIG. 4 is a schematic diagram illustrating a process 400 according to some embodiments of the present disclosure. For the purpose of discussion, the process 400 will be described with reference to FIG. 1. The process 400 may involve the first device 110, the second device 120 and the third device shown in FIG. 1.

The third device 130 transmits 405 an SRS to the first device 110 and the second device 120 transmits 410 a CSI RS to the first device 110. Upon receiving the SRS from the third device 130 and the CSI RS from the second device 120, the first device 110 determines 415 the first set of precoders associated with the first data transmission and the second set of precoders associated with the second data transmission, for example, based on the measurement on the SRS and CSI RS. For example, the first device 110 may determine the first set of precoders to be P1, P2, P3 and P4, and the second set of precoders to be P5 and P6.

Upon the generation of the first and second sets of precoders, the first device 110 transmits 420 to the second device 120 a first SRS precoded with the first set of precoders P1, P2, P3, P4 and a second SRS precoded with the second set of precoders P5, P6. The first device 110 may transmit the first and second SRSs on a first and second SRS resource sets, respectively, with one SRS resource set being configured for channel measurement and the other being configured for interference measurement. In this case, both the first and second SRS resource sets are configured to the first device 110 for the first link 101.

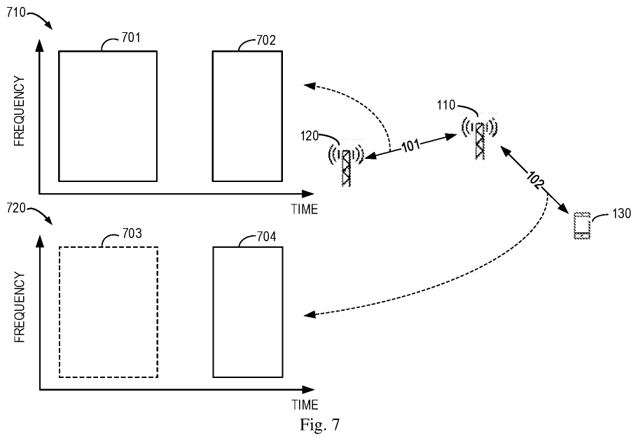

FIG. 5 shows schematic diagrams 510 and 520 illustrating resource sets configured for the first link 101 and the second link 102 according to such embodiments. The diagram 510 schematically shows the resource sets for the first link 101. The first SRS resource set 501 is configured for the first link 101 to transmit the first SRS and the second SRS resource set 502 is configured for the first link 101 to transmit the second SRS. The diagram 520 schematically shows the resource sets for the second link 102. The dashed blocks 503 and 504 represent that there is no resource set configured for the second link 102 at the frequency and time corresponding to the SRS resource sets 501 and 502.

Still referring to FIG. 4, upon receiving the first and second SRSs, the second device 120 selects 425 from the first set of precoders P1, P2, P3, P4, at least one precoder to be used for the first data transmission. The second device 120 may select the at least one precoder, based on the channel measurement on the first SRS resource set 501 and the interference measurement on the second SRS resource set 502. For example, the second device 120 may determine that the precoders P1 and P2 are preferred and select the precoders P1 and P2.

Then, the second device 120 transmits 430 an indication of the at least one selected precoder (e.g. P1, P2) to the first device 110, along with for example an UL grant for the first data transmission. As mentioned above, the at least one selected precoder may be indicated by the value of the SRI field. Upon receiving the indication and the UL grant for the first data transmission, the first device 110 may transmits 435 a DL grant for the second data transmission to the third device 130. After that, the first device 110 may perform the first data transmission with the at least one selected precoder (e.g. P1, P2) and perform the second data transmission with the second set of precoders P5, P6 concurrently.

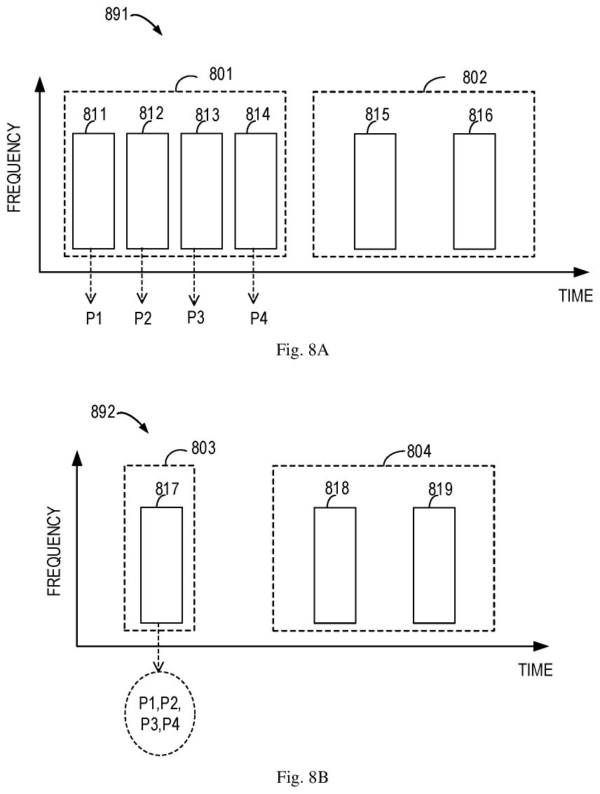

The first and second SRS resource sets 501, 502 shown in FIG. 5 may have different configurations. FIGS. 6A-6C show schematic diagrams 691-693 illustrating different configurations of the two SRS resource sets. Each of the configurations of the first SRS resource sets 601, 603, 605 represents a specific configuration of the first SRS resource set 501 as shown in FIG. 5. Each of the configurations of the second SRS resource sets 602, 604, 606 represents a specific configuration of the second SRS resource set 502 as shown in FIG. 5.

Referring to FIG. 6A, in some embodiments, the first SRS resource set 601, which is configured for the first link 101 and used for channel measurement, may comprise four SRS resources 611-614. For each of the four SRS resources 611-614, which corresponds to a single antenna port, the first SRS may be transmitted with one of the four precoders P1, P2, P3, P4, respectively. Thus, as schematically shown in FIG. 6A, the SRS resource 611 may be associated with the precoder P1, the SRS resource 612 may be associated with the precoder P2, the SRS resource 613 may be associated with the precoder P3, and the SRS resource 614 may be associated with the precoder P4.

The second SRS resource set 602, which is configured for the first link 101 and used for interference measurement, may comprise two SRS resources for interference measurement, which are referred to as SRS-IM resources 615-616. For each of the SRS-IM resources 615-616, which corresponds to a single antenna port, the second SRS may be transmitted with one of the precoders P5 and P6, respectively. As schematically shown in FIG. 6A, the SRS-IM resource 615 may be associated with the precoder P5 and the SRS-IM resource 616 may be associated with the precoder P6.

Referring to FIG. 6B, in some embodiments, the first SRS resource set 603, which is configured for the first link 101 and used for channel measurement, may comprise an SRS resource 617 corresponding to multiple antenna ports, for example, four antenna ports. For the SRS resource 617, the first SRS is transmitted with each of the four antenna ports being precoded with one of the precoders P1, P2, P3, P4, respectively. Thus, as schematically shown in FIG. 6B, the SRS resource 617 may be associated with the precoders P1, P2, P3, P4.

The second SRS resource set 604, which is configured for the first link 101 and used for interference measurement, may comprise two SRS-IM resources 618-619. For each of the SRS-IM resources 618-619, which corresponds to a single antenna port, the second SRS may be transmitted with one of the precoders P5, P6, respectively. As schematically shown in FIG. 6B and similar to the SRS-IM resources 615-616, the SRS-IM resource 618 may be associated with the precoder P5 and the SRS-IM resource 619 may be associated with the precoder P6.

Referring to FIG. 6C, in some embodiments, the first SRS resource set 605, which is configured for the first link 101 and used for channel measurement, may comprise four SRS resources 620-623. For each of the SRS resources 620-623, which corresponds to a single antenna port, the first SRS may be transmitted with one of the precoders P1, P2, P3, P4, respectively. Thus, as schematically shown in FIG. 6C and similar to the SRS resources 611-614, each of the SRS resources 620-623 may be associated with one of the precoders P1, P2, P3, P4, respectively.

The second SRS resource set 606, which is configured for the first link 101 and used for interference measurement, may comprise an SRS-IM resource 624 corresponding to multiple antenna ports, for example, two antenna ports. For the SRS-IM resource 624, the second SRS may be transmitted with each of the two antenna ports being precoded with one of the precoders P5, P6, respectively. Thus, as schematically shown in FIG. 6C, the SRS-IM resource 624 may be associated with the precoders P5, P6.

For the configurations of the resource sets shown in FIGS. 6A and 6B, the maximum number of transmission layer of the second data transmission from the first device 110 to the third device 130 is equal to or less than the number of SRS-IM resources. For the configuration of the resource sets shown in FIG. 6C, the maximum number of transmission layer of the second data transmission is equal to or less than the number of antenna ports corresponding to the SRS-IM resources.

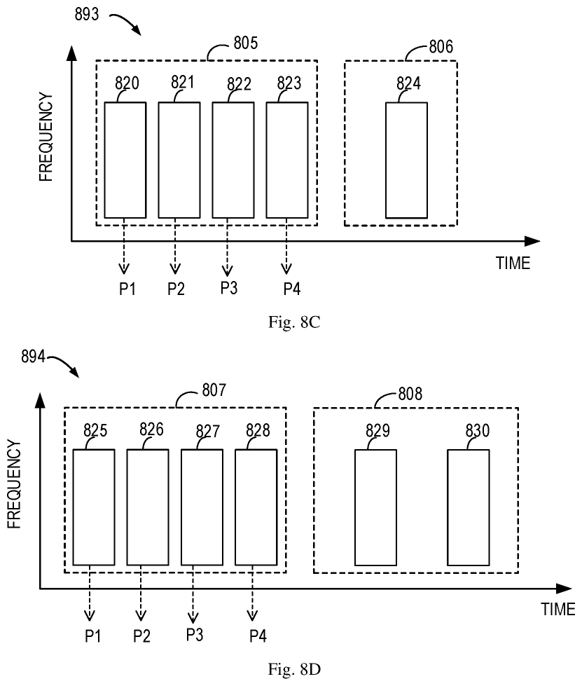

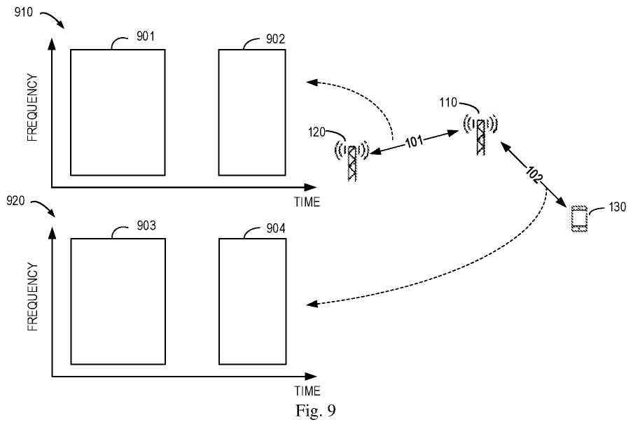

As mentioned above with reference to FIG. 2, in some embodiments, an SRS may be used as the first reference signal and a CSI-RS may be used as the second reference signal. Such embodiments are described with reference to FIGS. 7-8.

In such embodiments, the second reference signal (i.e. the NZP-CSI RS) is transmitted to the third device 130 rather than the second device 120. The SRS for channel measurement is transmitted on an SRS resource set configured to the first device 110 for the first link 101 and the NZP-CSI RS for interfere measurement is transmitted on an NZP-CSI RS resource set configured to the third device 130 for the second link 102.

FIG. 7 shows schematic diagrams 710 and 720 illustrating resource sets configured for the first link 101 and the second link 102 according to such embodiments. The diagrams 710 and 720 schematically show the resource sets for the first link 101 and for the second link 102, respectively. The SRS resource set 701 is configured for the first link 101 to transmit the SRS as the first reference signal. The dashed block 703 represents that there is no resource set configured for the second link 102 at the frequency and time corresponding to the SRS resource set 701.

The NZP-CSI RS resource set 704 for the second link 102 shares the same time-frequency resources with the ZP-CSI RS resource set 702 for the first link 101. The second reference signal (i.e. the NZP-CSI RS) is transmitted to the third device 130 using the NZP-CSI RS resource set 704. Since the corresponding ZP-CSI RS resource set 702 is configured for interference measurement in the first link 101, the second device 120 can perform interference measurement on the ZP-CSI RS resource set 702 in the first link 101. It is to be understood that the ZP-CSI RS resource set 702 and the NZP-CSI RS resource set 704 physically share the same time-frequency resources but they are logically configured for different links (i.e., the first link 101 and the second link 102).

FIGS. 8A-8D show schematic diagrams 891-894 illustrating different configurations of the SRS resource set for channel measurement and the ZP-CSI RS resource set for interference measurement. Each of the configurations of the SRS resource sets 801, 803, 805 and 807 represents a specific configuration of the SRS resource set 701 as shown in FIG. 7. Each of the configurations of the ZP-CSI RS resource sets 802, 804, 806 and 808 represents a specific configuration of the ZP-CSI RS resource set 702 as shown in FIG. 7.

Referring to FIG. 8A, in some embodiments, the SRS resource set 801, which is configured for the first link 101 and used for channel measurement, may comprise four SRS resources 811-814. For each of the SRS resources 811-814, which corresponds to a single antenna port, the SRS may be transmitted with one of the precoders P1, P2, P3, P4, respectively. Thus, as schematically shown in FIG. 8A, each of the SRS resources 811-814 may be associated with one of the precoders P1, P2, P3 and P4, respectively.

The ZP-CSI RS resource set 802, which is configured for the first link 101 and used for interference measurement, may comprise two ZP-CSI RS resources 815-816. The NZP-CSI RS resource set (e.g., the NZP-CSI RS resource set 704 shown in FIG. 7) for the second link 102, which shares the same time-frequency resources with the ZP-CSI RS resource set 802, may comprise two NZP-CSI RS resources (not shown) corresponding to the ZP-CSI RS resources 815-816. For each of the two NZP-CSI RS resources, the NZP-CSI RS may be transmitted with one of the precoders P5 and P6, respectively. Thus, the ZP-CSI RS resource 815 may be implicitly associated with the precoder P5 and the ZP-CSI RS resource 816 may be implicitly associated with the precoder P6.

Referring to FIG. 8B, in some embodiments, the SRS resource set 803, which is configured for the first link 101 and used for channel measurement, may comprise an SRS resource 817 corresponding to multiple antenna ports, for example, four antenna ports. For the SRS resource 817, the SRS is transmitted with each of the four antenna ports being precoded with one of the precoders P1, P2, P3, P4, respectively. Thus, as schematically shown in FIG. 8B, the SRS resource 817 may be associated with the precoders P1, P2, P3 and P4.

The ZP-CSI RS resource set 804, which is configured for the first link 101 and used for interference measurement, may comprise two ZP-CSI RS resources 818-819. The NZP-CSI RS resource set (e.g., the NZP-CSI RS resource set 704 shown in FIG. 7) for the second link 102, which shares the same time-frequency resources with the ZP-CSI RS resource set 804, may comprise two NZP-CSI RS resources (not shown) corresponding to the ZP-CSI RS resources 818-819. For each of the two NZP-CSI RS resources, the ZP-CSI RS may be transmitted with one of the precoders P5 and P6, respectively. Thus, the ZP-CSI RS resource 818 may be implicitly associated with the precoder P5 and the ZP-CSI RS resource 819 may be implicitly associated with the precoder P6.

Referring to FIG. 8C, in some embodiments, the SRS resource set 805, which is configured for the first link 101 and used for channel measurement, may comprise four SRS resources 820-823. For each of the SRS resources 820-823, which corresponds to a single antenna port, the SRS may be transmitted with one of the precoders P1, P2, P3, P4, respectively. Thus, as schematically shown in FIG. 8C, each of the SRS resource 820-823 may be associated with one of the precoders P1, P2, P3 and P4, respectively.

The ZP-CSI RS resource set 806, which is configured for the first link 101 and used for interference measurement, may comprise a ZP-CSI RS resource 824. The NZP-CSI RS resource set (e.g., the NZP-CSI RS resource set 704 shown in FIG. 7) for the second link 102, which shares the same time-frequency resources with the ZP-CSI RS resource set 806, may comprise an NZP-CSI RS resource (not shown) corresponding to the ZP-CSI RS resource 824. The NZP-CSI RS resource for the second link 102 may comprise multiple antenna ports, for example, two antenna ports. For the NZP-CSI RS resource, the NZP-CSI RS may be transmitted with each of the two antenna ports being precoded with one of the precoders P5, P6, respectively. Thus, the NZP-CSI RS resource set may be associated with the precoders P5 and P6, and the ZP-CSI RS resource 824 may therefore be implicitly associated with the precoders P5 and P6.

Referring to FIG. 8D, in some embodiments, the SRS resource set 807, which is configured for the first link 101 and used for channel measurement, may comprise four SRS resources 825-828. For each of the SRS resources 825-828, which corresponds to a single antenna port, the SRS may be transmitted with one of the precoders P1, P2, P3, P4, respectively. Thus, as schematically shown in FIG. 8D, each of the SRS resource 825-828 may be associated with one of the precoders P1, P2, P3 and P4, respectively.

Since more antenna ports may be available for the CSI RS, there may be additional precoders, such as P7 and P8, in the second set of precoders. In such cases, the ZP-CSI RS resource set 808, which is configured for the first link 101 and used for interference measurement, may comprise two ZP-CSI RS resources 829-830.

The NZP-CSI RS resource set (e.g., the NZP-CSI RS resource set 704 shown in FIG. 7) for the second link 102, which shares the same time-frequency resources with the ZP-CSI RS resource set 808, may comprise two NZP-CSI RS resources (not shown) corresponding to the ZP-CSI RS resources 829-830. Each of the two NZP-CSI RS resources may have multiple antenna ports, for example, two antenna ports. For the NZP-CSI RS resource sharing the same time-frequency resources with the ZP-CSI RS resource 829, the NZP-CSI RS may be transmitted with each of the two antenna ports being precoded with one of the precoders P5, P6, respectively. For the NZP-CSI RS resource sharing the same time-frequency resources with the ZP-CSI RS resource 830, the NZP-CSI RS may be transmitted with each of the two antenna ports being precoded with one of the precoders P7, P8, respectively. Thus, the ZP-CSI RS resource 829 may be implicitly associated with the precoders P5 and P6, and the ZP-CSI RS resource 830 may be implicitly associated with the precoders P7 and P8.

For the configurations of the resource sets shown in FIGS. 8A and 8B, the maximum number of transmission layer of the second data transmission is equal to or less than the number of ZP-CSI RS resources. For the configuration of the resource sets shown in FIGS. 8C and 8D, the maximum number of transmission layer of the second data transmission is equal to or less than the number of ZP-CSI RS resource ports multiplied by the number of ZP-CSI RS resources.

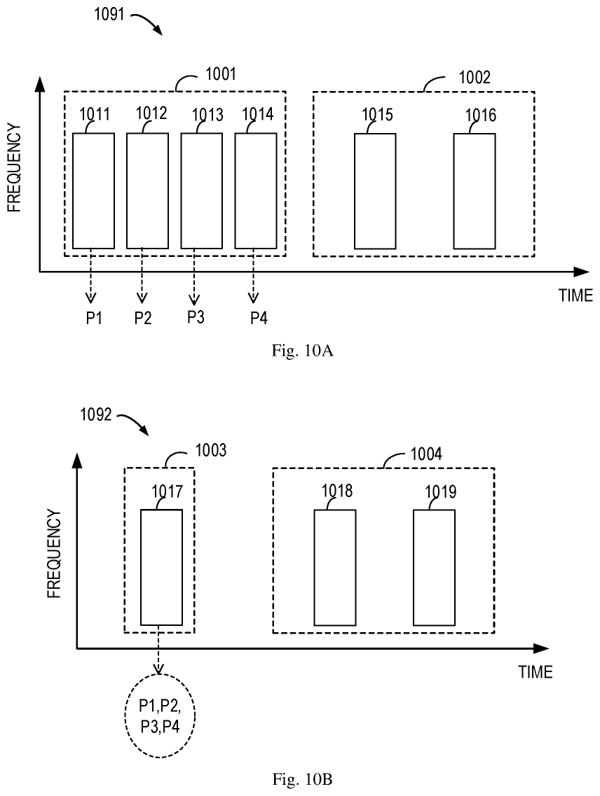

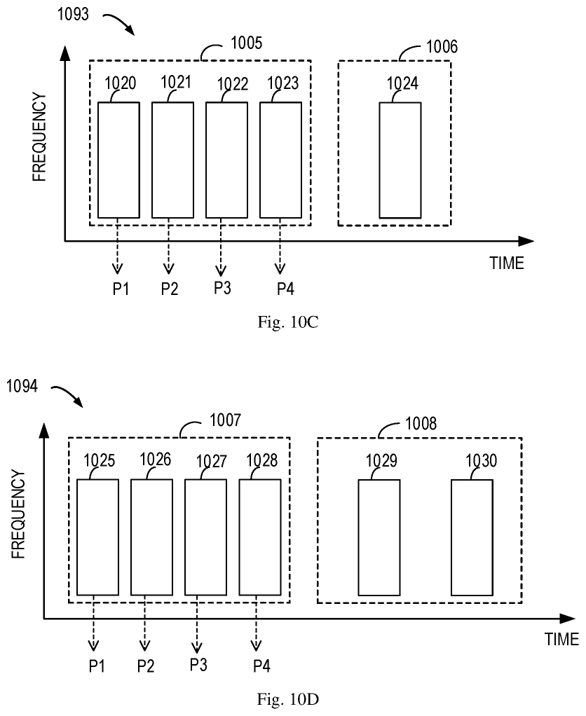

As mentioned above with reference to FIG. 2, in some embodiments, CSI-RSs may be used as both the first and second reference signals. Such embodiments are described with reference to FIGS. 9-10.

In such embodiments, the first NZP-CSI RS for channel measurement is transmitted on a first NZP-CSI RS resource set configured to the first device 110 for the first link 101 and a second NZP-CSI RS for interfere measurement is transmitted on a second NZP-CSI RS resource set configured to the third device 130 for the second link 102. The second NZP-CSI RS is transmitted to the third device 130 rather than the second device 120.

FIG. 9 shows schematic diagrams 910 and 920 illustrating resource sets configured for the first link 101 and the second link 102 according to such embodiments. The diagrams 910 and 920 schematically show the resource sets for the first link 101 and for the second link 102, respectively.

The NZP-CSI RS resource set 901 is configured for the first link 101 to transmit the first NZP-CSI RS. The NZP-CSI RS resource set 903 for the second link 102 shares the same time-frequency resources with the NZP-CSI RS resource set 901 for the first link 101. This means that when the first NZP-CSI RS is transmitted to the second device 120 using the NZP-CSI RS resource set 901 in the first link 101, CLI measurement may be performed on the NZP-CSI RS resource set 903 in the second link 102 by the third device 130.

The NZP-CSI RS resource set 904 for the second link 102 shares the same time-frequency resources with the ZP-CSI RS resource set 902 for the first link 101. The second reference signal (i.e. the second NZP-CSI RS) is transmitted to the third device 130 using the NZP-CSI RS resource set 904 in the second link 102. Since the corresponding ZP-CSI RS resource set 902 is configured for interference measurement at the first link 101, the second device 120 may perform interference measurement on the ZP-CSI RS resource set 902 in the first link 101. It is to be understood that the ZP-CSI RS resource set 902 and the NZP-CSI RS resource set 904 physically share the same time-frequency resources but they are logically configured for different links (i.e., the first link 101 and the second link 102).

FIGS. 10A-10D show schematic diagrams 1091-1094 illustrating different configurations of the CSI RS resource sets for channel measurement and for interference measurement. Each of the configurations of the NZP-CSI RS resource sets 1001, 1003, 1005 and 1007 represents a specific configuration of the NZP-CSI RS resource set 901 as shown in FIG. 9. Each of the configurations of the ZP-CSI RS resource sets 1002, 1004, 1006 and 1008 represents a specific configuration of the ZP-CSI RS resource set 902 as shown in FIG. 9.

Referring to FIG. 10A, in some embodiments, the NZP-CSI RS resource set 1001, which is configured to the first device 110 for the first link 101 and used for channel measurement, may comprise four NZP-CSI RS resources 1011-1014. For each of the NZP-CSI RS resources 1011-1014, which corresponds to a single antenna port, the NZP-CSI RS may be transmitted with one of the precoders P1, P2, P3, P4, respectively. Thus, as schematically shown in FIG. 10A, each of the NZP-CSI RS resources 1011-1014 may be associated with one of the precoders P1, P2, P3 and P4, respectively.

The ZP-CSI RS resource set 1002, which is configured to the first device 110 for the first link 101 and used for interference measurement, may comprise two ZP-CSI RS resources 1015-1016. The NZP-CSI RS resource set (e.g., the NZP-CSI RS resource set 904 shown in FIG. 9) for the second link 102, which shares the same time-frequency resources with the ZP-CSI RS resource set 1002, may comprise two NZP-CSI RS resources (not shown) corresponding to the ZP-CSI RS resources 1015-1016. For each of the two NZP-CSI RS resources, the NZP-CSI RS may be transmitted with one of the precoders P5 and P6, respectively. Thus, the ZP-CSI RS resource 1015 may be implicitly associated with the precoder P5 and the ZP-CSI RS resource 1016 may be implicitly associated with the precoder P6.

Referring to FIG. 10B, in some embodiments, the NZP-CSI RS resource set 1003, which is configured to the first device 110 for the first link 101 and used for channel measurement, may comprise an NZP-CSI RS resource 1017 corresponding to multiple antenna ports, for example, four antenna ports. For the NZP-CSI RS resource 1017, the NZP-CSI RS is transmitted with each of the four antenna ports being precoded with one of the precoders P1, P2, P3, P4, respectively. Thus, as schematically shown in FIG. 10B, the NZP-CSI RS resource 1017 may be associated with the precoders P1, P2, P3 and P4.

The ZP-CSI RS resource set 1004, which is configured to the first device 110 for the first link 101 and used for interference measurement, may comprise two ZP-CSI RS resources 1018-1019. The NZP-CSI RS resource set (e.g., the NZP-CSI RS resource set 904 shown in FIG. 9) for the second link 102, which shares the same time-frequency resources with the ZP-CSI RS resource set 1004, may comprise two NZP-CSI RS resources (not shown) corresponding to the ZP-CSI RS resources 1018-1019. For each of the two NZP-CSI RS resources, the NZP-CSI RS may be transmitted with one of the precoders P5 and P6, respectively. Thus, the ZP-CSI RS resource 1018 may be implicitly associated with the precoder P5 and the ZP-CSI RS resource 1019 may be implicitly associated with the precoder P6.

Referring to FIG. 10C, in some embodiments, the NZP-CSI RS resource set 1005, which is configured to the first device 110 for the first link 101 and used for channel measurement, may comprise four NZP-CSI RS resources 1020-1023. For each of the NZP-CSI RS resources 1020-1023, which corresponds to a single antenna port, the NZP-CSI RS may be transmitted with one of the precoders P1, P2, P3, P4, respectively. Thus, as schematically shown in FIG. 10C, each of the NZP-CSI RS resource 1020-1023 may be associated with one of the precoders P1, P2, P3 and P4, respectively.

The ZP-CSI RS resource set 1006, which is configured to the first device 110 for the first link 101 and used for interference measurement, may comprise a ZP-CSI RS resource 1024. The NZP-CSI RS resource set (e.g., the NZP-CSI RS resource set 904 shown in FIG. 9) for the second link 102, which shares the same time-frequency resources with the ZP-CSI RS resource set 1006, may comprise an NZP-CSI RS resource (not shown) corresponding to the ZP-CSI RS resource 1024. The NZP-CSI RS resource for the second link 102 may comprise multiple antenna ports, for example, two antenna ports. For the NZP-CSI RS resource, the NZP-CSI RS may be transmitted with each of the two antenna ports being precoded with one of the precoders P5, P6, respectively. Thus, the NZP-CSI RS may be associated with the precoders P5 and P6, and the ZP-CSI RS resource 1024 may therefore be implicitly associated with the precoders P5 and P6.

Referring to FIG. 10D, in some embodiments, the NZP-CSI RS resource set 1007, which is configured to the first device 110 for the first link and used for channel measurement, may comprise four NZP-CSI RS resources 1025-1028. For each of the NZP-CSI RS resources 1025-1028, which corresponds to a single antenna port, the NZP-CSI RS may be transmitted with one of the precoders P1, P2, P3, P4, respectively. Thus, as schematically shown in FIG. 10D, each of the NZP-CSI RS resource 1025-1028 may be associated with one of the precoders P1, P2, P3 and P4, respectively.

Similar to FIG. 8D, in some cases, the ZP-CSI RS resource set 1008, which is configured to the first device 110 for the first link and used for interference measurement, may comprise two ZP-CSI RS resources 1029-1030. The NZP-CSI RS resource set (e.g., the NZP-CSI RS resource set 904 shown in FIG. 9) for the second link 102, which shares the same time-frequency resources with the ZP-CSI RS resource set 1008, may comprise two NZP-CSI RS resources (not shown) corresponding to the ZP-CSI RS resources 1029-1030. Each of the two NZP-CSI RS resources may have multiple antenna ports, for example, two antenna ports. For the NZP-CSI RS resource sharing the same time-frequency resources with the ZP-CSI RS resource 1029, the NZP-CSI RS may be transmitted with each of the two antenna ports being precoded with one of the precoders P5, P6, respectively. For the NZP-CSI RS resources sharing the same time-frequency resources with the ZP-CSI RS resource 1030, the NZP-CSI RS may be transmitted with each of the two antenna ports being precoded with one of the precoders P7, P8, respectively. Thus, the ZP-CSI RS resource 1029 may be implicitly associated with the precoders P5 and P6, and the ZP-CSI RS resource 1030 may be implicitly associated with the precoders P7 and P8.

It is to be understood that the number of resources and the number of precoders associated therewith shown in FIGS. 6A-6C, 8A-8D and 10A-10D are merely for illustrative purpose without any limitation to the scope of the present disclosure. Each of the resource sets may include any suitable number of resources and precoders associated therewith.

As mentioned above, in some embodiments, the configurations of the first and second resource sets may be configured via RRC messages. For example, the pseudocodes to configure a resource set may be as follow:

```
CSI-ReportConfig ::= SEQUENCE {
  reportConfigId CSI-ReportConfigId,
  resourcesForChannelMeasurement
CHOICE {
    NZP-CSI-Resource-ConfigId
    SRS-CM-Resource- ConfigId
},
  IM-ResourcesForInterference
CHOICE {
    ZP-CSI-Resource- ConfigId
    NZP-CSI-Resource-ConfigId
    SRS-IM-Resource- ConfigId
},
  reportQuantity
}
```

For channel measurement (CM), either an NZP-CSI resource set or an SRS-CM resource set (i.e., SRS resource set for channel measurement) can be configured, and each of the NZP-CSI resource set and the SRS-CM resource set is indicated by a configuration ID, such as NZP-CSI-Resource-ConfigId for the NZP-CSI resource set and SRS-CM-Resource-ConfigId for the SRS-CM resource set. For interference measurement (IM), either a ZP-CSI Resource set, an NZP-CSI resource set or an SRS-IM resource set can be configured, and each of the ZP-CSI Resource set, the NZP-CSI resource set and the SRS-IM resource set is indicated by a configuration ID, such as ZP-CSI Resource-ConfigId for the ZP-CSI Resource set, NZP-CSI Resource-ConfigId for the NZP-CSI resource set and SRS-CM-Resource-ConfigId for the SRS-IM resource set.

Table 3 shows the configuration of resource sets to the first device 110 and to the third device 130.

TABLE 3
RRC configuration

| Configuration to the first device | | Configuration to the third device | |
|---|---|---|---|
| resources for | resources for | resources for | resources for |
| CM | IM | CM | IM |
| SRS-CM- | SRS-IM- | None | None |
| Resource- | Resource- | | |
| ConfigId | ConfigId | | |
| SRS-CM- | ZP-CSI- | None | NZP-CSI- |
| Resource- | Resource- | | Resource- |
| ConfigId | ConfigId | | ConfigId |
| NZP-CSI- | ZP-CSI- | NZP-CSI- | NZP-CSI- |
| Resource- | Resource- | Resource- | Resource- |
| ConfigId(1) | ConfigId(2) | ConfigId(2) | ConfigId(1) |

Table 3 may be better understood with respect to FIGS. 5, 7 and 9. For example, the third, fourth and fifth rows of Table 3 correspond to the allocation of the resource sets shown in FIGS. 5, 7 and 9, respectively. By this way, the resource sets may be configured to the first device 110 (e.g. an IAB node) and the third device 130 (e.g. a terminal device or a child IAB node), respectively. For each of the third, fourth and fifth rows, the first device 110 may associate the configuration in the first column with the configuration in the third column (if applicable), and may associate the configuration in the second column with the configuration in the fourth column (if applicable).

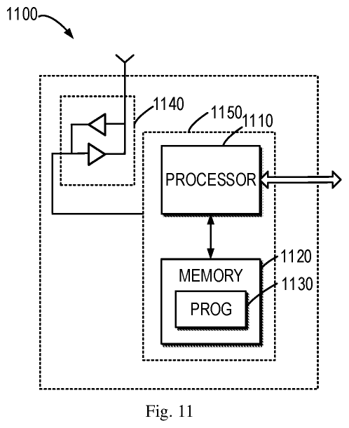

FIG. 11 is a simplified block diagram of a device 1100 that is suitable for implementing embodiments of the present disclosure. The device 1100 can be considered as a further example implementation of the first device 110, the second device 120 or the third device 130 as shown in FIG. 1. Accordingly, the device 1100 can be implemented at or as at least a part of the first device 110, the second device 120 or the third device 130.

As shown, the device 1100 includes a processor 1110, a memory 1120 coupled to the processor 1110, a suitable transmitter (TX) and receiver (RX) 1140 coupled to the processor 1110, and a communication interface coupled to the TX/RX 1140. The memory 1110 stores at least a part of a program 1130. The TX/RX 1140 is for bidirectional communications. The TX/RX 1140 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1130 is assumed to include program instructions that, when executed by the associated processor 1110, enable the device 1100 to operate in accordance with the embodiments of the present disclosure, as discussed herein with reference to FIG. 2 and FIG. 3. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1110 may form processing means 1150 adapted to implement various embodiments of the present disclosure.

The memory 1110 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1110 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 2-4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method for communication, comprising:
determining, at a first device, a first resource set and a second resource set, the first device operating in a half-duplex manner as a relay between a second device and a third device, the first resource set being configured to the first device for a first link between the first device and the second device, the second resource set being configured to the first device for the first link or to the third device for a second link between the first device and the third device; and
transmitting a first reference signal on the first resource set for channel measurement and a second reference signal on the second resource set for interference measurement.

2. The method of claim 1, wherein transmitting the first reference signal and the second reference signal comprises:
transmitting, to the second device, a first sounding reference signal (SRS); and
transmitting, to the second device, a second SRS, and
wherein the first resource set is a first SRS resource set configured to the first device for the first link, and the second resource set is a second SRS resource set configured to the first device for the first link.

3. The method of claim 1, wherein transmitting the first reference signal and the second reference signal comprises:
transmitting, to the second device, an SRS; and
transmitting, to the third device, a non-zero power channel state information reference signal (NZP-CSI RS), and
wherein the first resource set is an SRS resource set configured to the first device for the first link, and the second resource set is an NZP-CSI RS resource set configured to the third device for the second link.

4. The method of claim 1, wherein transmitting the first reference signal and the second reference signal comprises:
transmitting, to the second device, a first NZP-CSI RS; and
transmitting, to the third device, a second NZP-CSI RS, and
wherein the first resource set is a first NZP-CSI RS resource set configured to the first device for the first link, and the second resource set is a second NZP-CSI RS resource set configured to the third device for the second link.

5. The method of claim 1, wherein each resource in the first resource set is associated with one precoder in a first set of precoders, and each resource in the second resource set is associated with one precoder in a second set of precoders, the first set of precoders being associated with first data transmission from the first device to the second device, the second set of precoders being associated with second data transmission from the first device to the third device.

6. The method of claim 1, wherein the first resource set includes one resource associated with a first set of precoders, and each resource in the second resource set is associated with one precoder in a second set of precoders, the first set of precoders being associated with first data transmission from the first device to the second device, the second set of precoders being associated with second data transmission from the first device to the third device.

7. The method of claim 1, wherein each resource in the first resource set is associated with one precoder in a first set of precoders, and the second resource set includes at least one resource associated with at least some precoders in a second set of precoders, the first set of precoders being associated with first data transmission from the first device to the second device, the second set of precoders being associated with second data transmission from the first device to the third device.

8. The method of claim 1, further comprising:
receiving, from the second device, a first and second radio resource control (RRC) messages, the first RRC message comprising a first configuration of the first resource set and a third configuration of a third resource set configured to the first device for the first link, the second RRC message comprising a fourth configuration of a fourth resource set configured to the third device for the second link and a fifth configuration of a fifth resource set configured to the third device for the second link;
associating the first configuration with the fourth configuration and the third configuration with the fifth configuration, and
wherein the second resource set comprises one of the third resource set and the fifth resource set.

9. The method of claim 1, wherein the first device comprises an integrated access and backhaul (IAB) node, and the second device comprises an IAB donor.

10. A method for communication, comprising:
receiving, from a first device and at a second device, a first reference signal on a first resource set and a second reference signal on a second resource set, the first device operating in a half-duplex manner as a relay between the second device and a third device, the first resource set being configured to the first device for a first link between the first device and the second device, the second resource set being configured to the first device for the first link or to the third device for a second link between the first device and the third device; and
performing channel measurement on the first reference signal and interference measurement on the second reference signal.

11. The method of claim 10, wherein receiving the first reference signal and the second reference signal comprises:
receiving, on the first resource set, a first sounding reference signal (SRS); and
receiving, on the second resource set, a second SRS, and
wherein the first resource set is a first SRS resource set configured to the first device for the first link, and the second resource set is a second SRS resource set configured to the first device for the first link.

12. The method of claim 10, wherein receiving the first reference signal and the second reference signal comprises:
receiving, on the first resource set, an SRS; and
receiving a non-zero power channel state information reference signal (NZP-CSI RS) as a reference signal for interference measurement, and
wherein the first resource set is an SRS resource set configured to the first device for the first link, and the second resource set is an NZP-CSI RS resource set configured to the third device for the second link.

13. The method of claim 10, wherein receiving the first reference signal and the second reference signal comprises:
receiving, on the first resource set, a first NZP-CSI RS; and
receiving a second NZP-CSI RS as a reference signal for interference measurement and
wherein the first resource set is a first NZP-CSI RS resource set configured to the first device for the first link, and the second resource set is a second NZP-CSI RS resource set configured to the third device for the second link.

14. The method of claim 10, wherein each resource in the first resource set is associated with one precoder in a first set of precoders, and each resource in the second resource set is associated with one precoder in a second set of precoders, the first set of precoders being associated with first data transmission from the first device to the second device, the second set of precoders being associated with second data transmission from the first device to the third device.

15. The method of claim 10, wherein the first resource set includes one resource associated with a first set of precoders, and each resource in the second resource set is associated with one precoder in a second set of precoders, the first set of precoders being associated with first data transmission from the first device to the second device, the second set of precoders being associated with second data transmission from the first device to the third device.

16. The method of claim 10, wherein each resource in the first resource set is associated with one precoder in a first set of precoders, and the second resource set includes at least one resource associated with at least some precoders in a second set of precoders, the first set of precoders being associated with first data transmission from the first device to the second device, the second set of precoders being associated with second data transmission from the first device to the third device.

17. The method of claim 10, further comprising:
transmitting, to the first device, a first and second radio resource control (RRC) message, the first RRC message comprising a first configuration of the first resource set and a third configuration of a third resource set configured to the first device for the first link, the second RRC message comprising a fourth configuration of a fourth resource set configured to the third device for the second link and a fifth configuration of a fifth resource set configured to the third device for the second link, and
wherein the first configuration is associated with the fourth configuration and the third configuration is associated with the fifth configuration, and the second resource set comprises one of the third resource set and the fifth resource set.

18. The method of claim 10, wherein the first device comprises an integrated access and backhaul (IAB) node, and the second device comprises an IAB donor.

19. A device, comprising:
a processor; and
a memory coupled to the processing unit and storing instructions thereon, the instructions, when executed by the processing unit, causing the device to:
determine a first resource set and a second resource set, the device operating in a half-duplex manner as a relay between a second device and a third device, the first resource set being configured to the device for a first link between the device and the second device, the second resource set being configured to the device for the first link or to the third device for a second link between the device and the third device; and
transmit a first reference signal on the first resource set for channel measurement and a second reference signal on the second resource set for interference measurement.

20.-22. (canceled)

23. The device of claim 19, wherein the instructions, when executed by the processing unit, cause the device to:
transmit, to the second device, a first sounding reference signal (SRS); and
transmit, to the second device, a second SRS, and
wherein the first resource set is a first SRS resource set configured to the device for the first link, and the second resource set is a second SRS resource set configured to the device for the first link.
